(19) United States
(12) Patent Application Publication
(10) Pub. No.: US 2021/0370925 A1
(43) Pub. Date: Dec. 2, 2021

(54) CONTENT-ADAPTIVE LOSSY COMPRESSION OF MEASURED DATA

(71) Applicant: Robert Bosch GmbH, Stuttgart (DE)

(72) Inventors: Holger Janssen, Hessisch Oldendorf (DE); Arne Zender, Bad Salzdetfurth (DE); Beke Junge, Hildesheim (DE)

(21) Appl. No.: 17/278,179

(22) PCT Filed: Nov. 26, 2019
(86) PCT No.: PCT/EP2019/082522

§ 371 Date: Mar. 19, 2021

(30) Foreign Application Priority Data
Dec. 17, 2018 (DE) 10 2018 221 920.6

(51) Int. Cl. B60W 30/09; B60W 10/04; B60W 10/18; B60W 10/20; B60W 50/16; B60Q 9/00; H04N 19/139; H04N 19/167; G05D 1/02

(52) U.S. Cl. CPC B60W 30/09; G06K 9/00805; B60W 10/18; B60W 10/20; B60W 50/16; B60Q 9/008; H04N 19/139; H04N 19/167; G05D 1/0246; G05D 1/0238; G05D 1/0257; B60W 2710/18; B60W 2710/20; B60W 2420/42; B60W 2420/52; B60W 10/04

(57) ABSTRACT

A method for lossy compression of measured data obtained through physical observation of a detection area. The method includes: the measured data and/or data prepared therefrom are divided with respect to at least one criterion into a plurality of classes and/or regions; the classes and/or regions are assigned priorities with respect to the intended evaluation of the measured data or to the data prepared therefrom; temporal changes of the measured data and/or of the data prepared therefrom divided into each class or region are compressed in a lossy manner, the degree of compression being a function of the priority assigned to the class or region. A method for monitoring a vehicle driving in traffic, and/or for controlling a vehicle driving at least in a semi-automated manner in traffic using the method for lossy compression, a compression module, camera, radar module or LIDAR module, and computer program, are also described.

### FIELD

The present invention relates to the lossy compression of measured data, in particular, for detecting the surroundings of vehicles.

### BACKGROUND INFORMATION

When a vehicle is driven by a human driver in traffic, pieces of visual information from the vehicle surroundings are the most important information source. Accordingly, driving assistance systems as well as systems for the at least semi-automated driving also use one or multiple digital cameras or other imaging systems for detecting the vehicle surroundings. With the number of cameras and their pixel resolution and color depth, the volume of the data traffic to be transported within the vehicle is sharply increasing.

U.S. Patent Application Publication No. US 2018/131 950 A1 describes a method, with which moving objects may be extracted from a setting. The information about movements of these objects may then be transferred in the form of metadata to these objects in a highly compressed manner.

PCT Application No. WO 2016/181 150 A1 describes a method, with which images of a permanently mounted camera are able to be adaptively compressed image for image to the extent that the details of faces remain unchanged, while the background is blurred or otherwise compressed in a lossy manner.

U.S. Patent Application Publication No. US 2016/366 364 A1 describes an accident data recorder which, in addition to compressed image data, also stores metadata of identified objects so that the pieces of information important for the reconstruction of the accident are not affected by the compression of the image data.

### SUMMARY

Within the scope of the present invention, a method is provided for the lossy compression of measured data, which have been obtained through physical observation of a detection area. The measured data may, for example, be image data that have been recorded by a camera, but also, for example, radar data or LIDAR data. The detection area may be located, in particular, in the surroundings of a vehicle.

In accordance with an example embodiment of the present invention, the measured data and/or data prepared therefrom are divided with respect to at least one criterion into a plurality of classes and/or regions, to which in turn priorities are assigned with respect to the intended evaluation of the measured data or of the prepared data. Temporal changes of the measured data and/or prepared data divided into each class or region are compressed in a lossy manner. The degree of compression in this case is a function of the priority that is assigned to this class or region.

The term “measured data” in this case refers to raw data as they are fed by the respective sensor, whereas the term “prepared data” refers to arbitrary processing products produced from these raw data. In the case of camera images, it is possible, for example, to carry out an image improvement or an adaptation to the sensor properties or scene properties such as, for example, an adaptation to environmental influences. These environmental influences may include, for example, the brightness, the weather or country-specific features.

The division into classes may be arbitrarily motivated by what is important in the context of the task to be solved with the aid of the measured data. Thus, for example, tree tops and other areas not reachable for a vehicle are significantly less important in the context of a driving task than other road users. The division into regions may be similarly motivated.

A region in this case may be composed, in particular, of one or of multiple objects such as, for example, traffic objects (for example, persons, vehicle or obstacles), infrastructure objects (for example, roadways, lanes, markings, traffic signs, signaling systems, lights or traffic islands) or scene objects (for example, houses, vegetation, sky, mountains, lakes or beaches). Conversely, however, an object may also be made up of multiple regions or break down into these regions.

Objects may be divided into multiple regions, in particular, when subareas of the object behave differently with respect to the task to be solved with the aid of the measured data, for example, a driving task.

For example,
the various body parts of a person such as, for example, arms, legs, body or head, may be separately modelled;
various parts of vehicles such as, trailer, tractor, brake lights or turn signals, may form separate regions;
accumulations of traffic signs on a pole may be disassembled to form individual traffic signs; and/or
vehicles may be subdivided into their main body and parts pivotable therefrom such as doors or flaps.

Objects may be combined to form regions, in particular, when they behave similarly. For example,
various separate houses in a series of houses may be combined to form a row of houses;
various individual trees or bushes may form a hedgerow as a common region; and/or
various rocks at the roadside may be combined to form a road boundary or a curb.

It has been found that, in particular, during monitoring of the surroundings of a vehicle moving in traffic, a relative movement constantly takes place between the sensors used for detecting the measured data on the one hand and the detection area on the other hand. In contrast to the monitoring of an area using a permanently mounted security camera, for example, there is therefore no essentially static background in the measured data against which objects of interest already stand out as a result of their movement. Instead, the measured data are entirely time-variable. Thus, for example, in a video data stream recorded when a vehicle is driving straight ahead, no image is like the other, since the perspective of the vehicle changes continually relative to the setting. New objects continually enter into the detection area and other objects depart the detection area.

At the same time, the time-variable portions of the measured data in particular also contain the most important pieces of information for handling the driving task. A large part of the driving task is adapting the behavior of the host vehicle to the behavior of other road users. In the process, sudden unforeseen events such as, for example, a pedestrian entering the roadway, must be quickly responded to.

In accordance with an example embodiment of the present invention, by now compressing the temporal changes with different degrees of compression depending on the priority, it is possible to save a great deal of bandwidth during the data transfer within the vehicle. Thus, for example, detailed images of tree tops are compressible only to a minimum degree before details are lost and compression artifacts become visible. Since however the tree tops are normally not reachable for the vehicle, the preservation of details does not matter in regions that contain only tree tops. Temporal changes of the images belonging to these regions may thus be very highly compressed or even completely omitted.

This savings of bandwidth becomes all the more important, the greater the number of cameras and other sensors that are installed in vehicles and the greater the data rate per camera or per sensor becomes. In order, for example, to visually monitor the complete surroundings of the vehicle, multiple cameras must be distributed across the vehicle. In most vehicles, there is already a network with the CAN bus, which extends through the entire vehicle, however, the bandwidth is limited to a maximum of 1 Mbit/s. The manufacturer of the vehicle is therefore faced with the choice of either managing with the available bandwidth or providing a more efficient network.

However, the bandwidth savings is also meaningful when, in principle, sufficient network bandwidth for the transfer within the vehicle is available. Regardless of whether, for example, the CAN bus or an Ethernet network is used, one physical medium is generally always divided at at least one point among multiple users of the network. This means that invariably only one user at a time is able to transmit while other users must wait. If fewer less important pieces of information such as, for example, tree tops, are transferred over the network, then important information such as, for example, the pedestrian entering the roadway takes precedence instead. In this way, it is possible to reduce the response time of a driving-dynamic system to such important events. Each meter of stopping distance gained in this way counts.

The degree of compression may be arbitrarily set. For example, many lossy compression algorithms have parameters, with which the balance between preservation of details and efficiency of the compression may be set. The measured data may, however, also be discretized with variable intensity, for example, and/or blurred in order to make them more readily compressible.

In one particularly advantageous embodiment of the present invention, the temporal changes of the detection area, which may be vehicle surroundings, for example, are coded in the form of a flow field that includes a sequence of flow vectors. With such a representation, it is possible to describe, in particular, correspondences between images and other data sets that have been recorded in temporal sequence. As explained above, such correspondences exist particularly when a vehicle travels through a setting: in general, the setting does not completely change from one moment to the next, rather the majority of the changes are caused by the changed observation perspective.

For sequences of two-dimensional images, for example, the correspondences between an earlier image and a later image may be coded in the form of vectors x, y, u, v, with x and y being the coordinates of a point in the earlier image and u and v being the coordinates of the point in the later image corresponding thereto. If all changes between the earlier image and the later image are detected in this way, no savings of bandwidth or storage requirement is initially gained, rather the need compared to a storage or transfer of the two complete images is even increased. However, the coding of temporal changes as a temporal sequence of flow vectors offers a particularly advantageous approach for setting the degree of compression: For the purpose of compression, a portion of the flow vectors, higher or lower depending on the desired degree of compression, may be discarded from the temporal sequence.

Thus, it may be established, for example, that only every nth flow vector is taken into consideration for the further processing, n being selected for each class and/or region corresponding to the priority established for this class or region. For vegetation, for example, only every tenth flow vector may be taken into consideration, whereas for pedestrians every second flow vector is taken into consideration.

A compression of this type has, in particular, the advantage that the omission of flow vectors in the temporal sequence of the measured data in the relevant areas merely results in a delayed updating. If, for example, a tree top is classified as less important, it remains in a static state when the associated flow vectors are omitted. However, this static state, in contrast, for example, to JPEG compression or MPEG compression, is not changed by compression artifacts. The work of downstream processing stages, which extract objects or their behavior from the measured data, for example, is not disrupted. The object identification using neural networks or other Kl modules could, for example, be hampered by compression artifacts. In this case, the edge areas of objects or combined objects may be handled separately if needed.

In one advantageous embodiment of the present invention, the measured data include two-dimensional images, and the prepared data include a three-dimensional reconstruction obtained from these image data. This reconstruction may be obtained, for example, stereoscopically from two simultaneously recorded camera images or via a “structure from motion” algorithm from a temporal sequence of camera images. A three-dimensional representation offers more flexible possibilities for dividing the data into classes and regions. Thus, it is possible to better tailor the degree of compression to the need with respect to the final evaluation of the measured data.

In one particularly advantageous embodiment of the present invention, the prepared data contain a semantic segmentation of the measured data, and/or at least one criterion for dividing the measured data and/or the prepared data into classes and/or regions is predefined by a semantic segmentation of measured data.

Thus, for example, the measured data, or the product of a pre-processing thereof, may be sorted as to which class or region they belong, but otherwise remain unchanged. However, the measured data may also, for example, be abstracted to the extent that they are replaced by the classification (label) that is assigned to them within the scope of a semantic segmentation. In this way, it is possible to compress a color image having an arbitrary color depth (for example, 16.7 million colors) to form a color image, which has only as many colors as there are different classes or object individuals of one class in the semantic segmentation.

The semantic segmentation is particularly meaningful within the scope of a driving task, in particular, with respect to the importance of objects. Thus, for example, it is known in advance that fixed objects such as traffic signs or trees do not of their own accord suddenly set a collision course with a vehicle. By contrast, pedestrians or also cyclists on the one hand suddenly change their movement behavior and on the other hand are unprotected in the event of a collision. It is therefore particularly important to track in detail the behavior of pedestrians and cyclists in order to avoid such collisions.

In one further advantageous embodiment of the present invention, the prepared data contain a classification of objects, whose presence is indicated by the measured data, and/or at least one criterion for the division of the measured data and/or prepared data into classes and/or regions is predefined by such a classification of objects. Similar to the semantic segmentation, the classification may be used to order the measured data or the prepared data according to their importance, in particular, with respect to a driving task. In this case, the classification may also, for example, be downstream of the semantic segmentation and, in particular, form a finer subdivision. Thus, the measured data may, for example, be initially segmented to the extent that a particular portion of these measured data represents traffic signs, and a classification as to which traffic signs are involved may then be made.

Traffic signs may differ between one another with respect to their importance for the driving task. Thus, for example, regulatory signs such as a stop sign, which necessarily dictate a specific behavior, are more important than hazard signs, which merely prompt an anticipatory adjustment to a particular hazard (for example, toad migration, deer crossing or slippery when wet). Some traffic signs (for example, yield signs) at intersections are also, for example, normally overridden by the traffic light also present at the intersection and take effect only when the traffic light has malfunctioned. Traffic signs may also influence one another in terms of their importance. Thus, for example, an auxiliary sign, which limits the validity of a traffic sign mounted above it to particular time periods or to the case of wet conditions on the roadway, may completely cancel and thus render unimportant the aforementioned traffic sign if the condition cited on the auxiliary sign is not applicable.

In one further particularly advantageous embodiment of the present invention, the prepared data contain a prognosis of the movement behavior of objects, and/or at least one criterion for dividing the measured data and/or the prepared data into classes and/or regions is predefined by such a prognosis of the movement behavior. The measured data may thus, for example, be divided as to what extent the object to which they relate is probably moved. Similar to the semantic segmentation, the preparation based on the prognosis of the movement behavior may also, for example, go so far that only the prognosis of the movement behavior is retained for further processing, whereas the underlying raw data are discarded. The compression in this case may generate more abstract scene descriptions.

The prognosis of the movement behavior is particularly well suited within the scope of a driving task for differentiating which measured data are important. Thus, for example, objects that affect an instantaneously driven trajectory and/or a planned trajectory of a vehicle are particularly important. By contrast, objects that move away from the vehicle are less important. As explained above, a stronger compression of the data for less important objects results in the data for more important objects instead taking precedence when processed. In this way, it is possible to shorten the response time of a driving-dynamic system.

This example and the other examples described above show that the described method for lossy compression is suited, in particular, for drastically reducing in volume data from the surroundings of a vehicle collected for handling a driving task while maintaining as best as possible the factual content relevant for the driving task. The present invention therefore also relates to a method for monitoring a vehicle driving in traffic, and/or for controlling a vehicle driving in at least a semi-automated manner in traffic.

In this method, in accordance with an example embodiment of the present invention, the measured data are detected through physical observation of at least a portion of the surroundings of the vehicle. Temporal changes of the measured data and/or data prepared therefrom are compressed using the above-described method. The compressed data are subsequently used for evaluating whether there are objects in the vehicle surroundings, which affect an instantaneously driven trajectory and/or a planned trajectory of the vehicle.

In the process, the at least one priority assigned to a class and/or region may be based on whether an object represented by measured data and/or prepared data of this class and/or region potentially affects an instantaneously driven trajectory and/or a planned trajectory of the vehicle, and/or whether this object may collide with the vehicle. This depends not only on the behavior of the object, but also on the instantaneous or planned behavior of the host vehicle. Thus, for example, trees do not by themselves set a collision course with vehicles; if, however a vehicle steers toward a tree, countermeasures are required.

Similarly, the ranking of which objects and regions are important and which are not may completely change if, for example, the vehicle turns at an intersection onto another street. By checking whether the instantaneously driven or planned trajectory is affected, the compression is continuously adapted to the instantaneous need for the driving task.

In one particularly advantageous embodiment of the present invention, a physical warning device perceptible to the driver of the vehicle is activated in response to the fact that there is at least one object in the vehicle surroundings that affects an instantaneously driven trajectory and/or a planned trajectory of the vehicle, and/or a steering system, drive system and/or a braking system of the vehicle is/are activated to the extent that the object no longer affects the then new trajectory of the vehicle.

As explained above, a preferably short response time is essential specifically for such countermeasures. The response time is advantageously reduced as a result of the described content-adaptive compression. In addition, more complex situations may also be identified, because a predefined equipping of hardware (for example, computing power, memory capacity and/or transfer bandwidth) is optimally utilized.

The method for content-adaptive compression in accordance with an example embodiment of the present invention, may, for example, be embodied in a compression module. This compression module is connectable on the input side with at least one sensor, which provides a pictorial representation of at least one portion of the surroundings of the vehicle. The compression module is connectable on the output side with a component-internal data line and/or with a bus system and/or a network of the vehicle. In this case, “connectable” may, in particular, be understood to mean that the compression module includes corresponding interfaces. The compression module is designed to carry out the described method for lossy compression.

The compression module may be integrated, in particular, into a camera, into a radar module or into a LIDAR module and has the effect then of particularly strongly compressing the data provided by the camera, by the radar module or by the LIDAR module to the bus system or to the network of the vehicle and of requiring little bandwidth. The present invention therefore also relates to a camera, to a radar module or to a LIDAR module for the pictorial recording of at least one portion of the surroundings of a vehicle with the described compression module. The compression module may also be contained in an arbitrary other system component. There may, if needed, also be multiple compression modules in the system.

The example methods in accordance with the present invention may be wholly or partially implemented in a software and, for example, upgrade an existing system for the processing of measured data, and/or an existing driving dynamic system in such a way that the above-described customer benefits are added. The software may thus be sold, in particular, as an update or upgrade for existing systems and to that extent is a separate product. The present invention therefore also relates to a computer program including machine-readable instructions which, when they are executed on a computer and/or on a control unit, prompt the computer and/or the control unit to carry out one of the described methods. The present invention also relates to a machine-readable data medium or download product that includes the computer program.

### BRIEF DESCRIPTION OF THE DRAWINGS

Further measures improving the present invention are illustrated with reference to figures in greater detail below, together with the description of the preferred exemplary embodiments of the present invention.

FIG. 1 shows an exemplary embodiment of method 400, in accordance with the present invention.

FIG. 2 shows examples of possible preparations 31 through 36 of measured data 1a, 2a in preparation for method 400, in accordance with the present invention.

FIG. 3 shows exemplary semantic segmentation 33 of image data 1a, 2a for application in method 400, in accordance with the present invention.

FIG. 4 shows an exemplary application of method 400 in conjunction with multiple sensors 1a through 1d, in accordance with the present invention.

FIG. 5 shows an exemplary embodiment of method 900, in accordance with the present invention.

FIG. 6 shows an exemplary application situation for method 900 at a vehicle, in accordance with the present invention.

### DETAILED DESCRIPTION OF EXAMPLE EMBODIMENTS

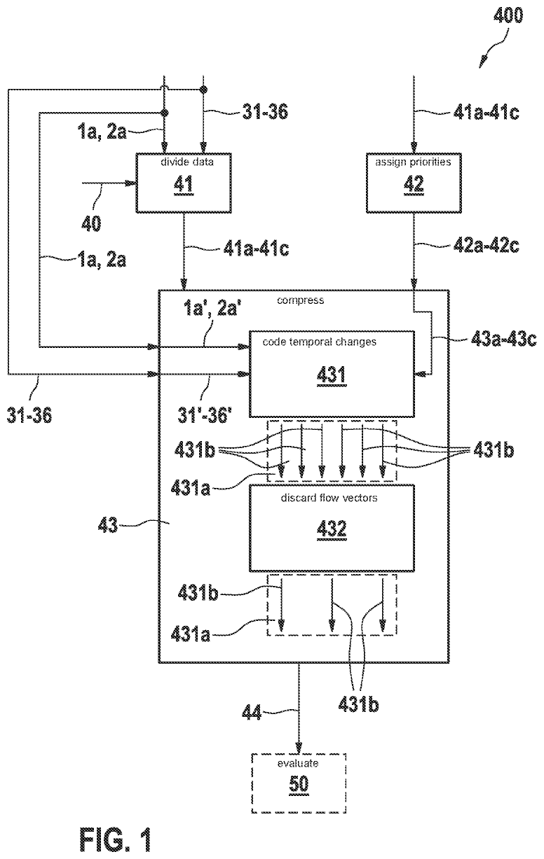

According to FIG. 1, the measured data and/or data 31 through 36 prepared therefrom are divided with respect to at least one criterion 40 in step 41 of method 400 into a plurality of classes and/or regions 41a through 41c. Classes and/or regions 41a through 41c are also assigned priorities 42a through 42c in step 42. These priorities are motivated by intended evaluation 50 of measured data 1a, 2a or of prepared data 31 through 36.

In step 43, temporal changes 1a′, 2a′, 31′ through 36′ of measured data 1a, 2a divided into each class or region 41a through 41c, and/or of prepared data 31 through 36 are now compressed in a lossy manner. In this case, in particular, for example, according to block 431, temporal changes 1a′, 2a′, 31′ through 36′ may be coded in the form of a flow field 431a that includes a temporal sequence of flow vectors 431b. Such flow vectors 431b may be ascertained, for example, from the comparison of successive images of an image data stream.

According to block 432, for example, compression 43 of flow field 431a may now include discarding flow vectors 431b from the temporal sequence. Depending on class and/or region 41a through 41c, for example, only every nth flow vector 431b may be taken into consideration, where n varies depending on degree of compression 43a through 43c assigned to class and/or region 41a through 41c. In this case, degree of compression 43a through 43c is a function, in particular, of priority 42a through 42c, which is assigned to respective class or region 41a through 41c.

Compressed data 44 result with respect to temporal changes 1a′, 2a′, 31′ through 36′ of measured data 1a, 2a or of data 31 through 36 prepared therefrom. During actual evaluation 50 with respect to the respective application, which is no longer part of method 400 itself, it is possible to reconstruct from the history of temporal changes 1a′, 2a′, 31′ through 36′ contained in compressed data 44 lossy versions of measured data 1a, 2a or of data 31 through 36 prepared therefrom. As mentioned above, the loss may be, in particular, that particular areas of measured data 1a, 2a or data 31 through 36 prepared therefrom are belatedly updated or not updated at all. Furthermore, no compression artifacts result, however. Edge areas of objects or object groups are handled separately if needed.

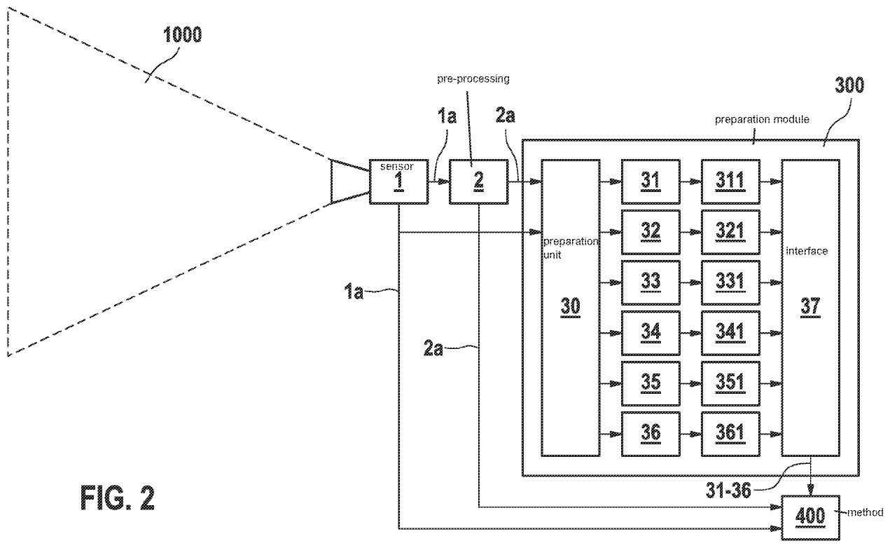

Exemplary possible preparations 31 through 36 of measured data 1a, 2a are indicated in FIG. 2. A sensor 1 is used for physically observing a detection area 1000 and provides measured data 1a. These measured data 1a may be optionally utilized directly in raw form or initially improved in a pre-processing 2 in summary form to pre-processed measured data 2a, in the case of image data, for example, by adapting brightness and contrast.

The measured data may be fed to method 400 in their raw form 1a and/or in their pre-processed form 2a. Measured data 1a, 2a may alternatively or in combination be fed to a preparation module 300, which provides prepared data 31 through 36 to method 400.

Preparation module 300 includes a preparation unit 30 which, in the example shown in FIG. 2
ascertains a flow 31 ascertained from measured data 1a, 2a and stores it in memory 311, and/or
ascertains a three-dimensional reconstruction 32 from measured data 1a, 2a and stores it in memory 321, and/or
ascertains a semantic segmentation 33 of measured data 1a, 2a and stores it in memory 331, and/or
ascertains a classification 34 of objects 1001 indicated by measured data 1a, 2a and stores it in memory 341, and/or
ascertains a prognosis 35 of the movement behavior of objects 1001 from measured data 1a, 2a and stores it in memory 351, and/or
ascertains another preparation 36 from measured data 1a, 2a and stores it in memory 361.

Preparations 31 through 36 are transferred via interface 37 from preparation module 300 to method 400, which may, for example, be embodied in a compression module 90.

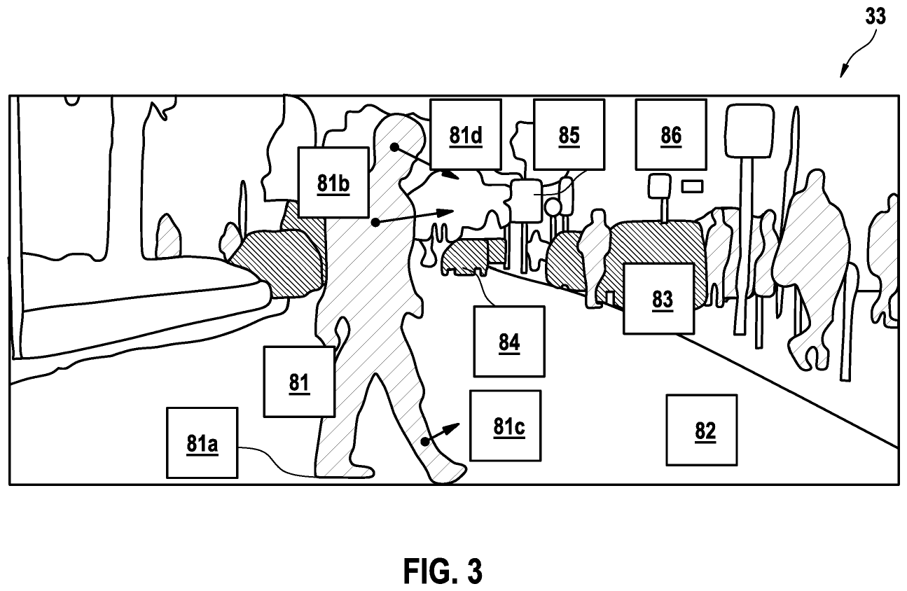

FIG. 3 shows an exemplary semantic segmentation 33. The setting has been abstracted according to types of objects with differences in importance. These are, in particular, a pedestrian 81, a street level 82, parked vehicles 83, preceding vehicles 84, traffic signs 85 and buildings 86. For controlling and/or monitoring a vehicle, static objects such as, for example, parked vehicles 83 and buildings 86 are significantly less important than the movement intentions of pedestrian 81. In order to capture these movement intentions in greater detail, the pedestrian may, for example, be described by his/her base point 81a on the road, by the movement of his/her body 81b, his/her arms and legs 81c, as well as by the viewing direction of his/her head 81d. The arrows delineated in FIG. 3 indicate in each case exemplary vectors, with which movements of corresponding regions may be coded.

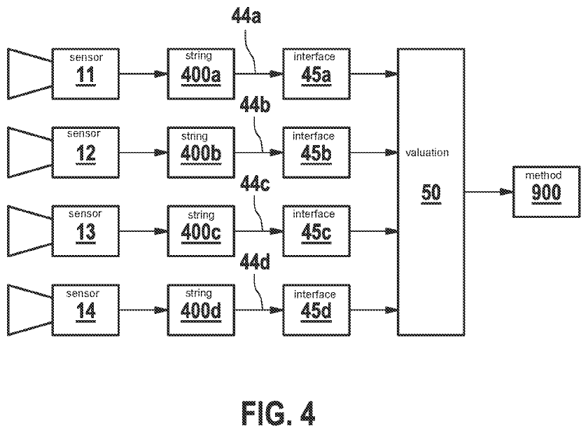

FIG. 4 shows by way of example how method 400 may be utilized in conjunction with multiple sensors 11 through 14. For each sensor 1a through 1d, method 400 is carried out in a separate string 400a through 400d. This results in each case in compressed data 44a through 44d, which are output in each case via interfaces 45a through 45d to intended valuation 50. This evaluation 50 may, for example, be used within the scope of method 900 for monitoring or for controlling a vehicle 1010.

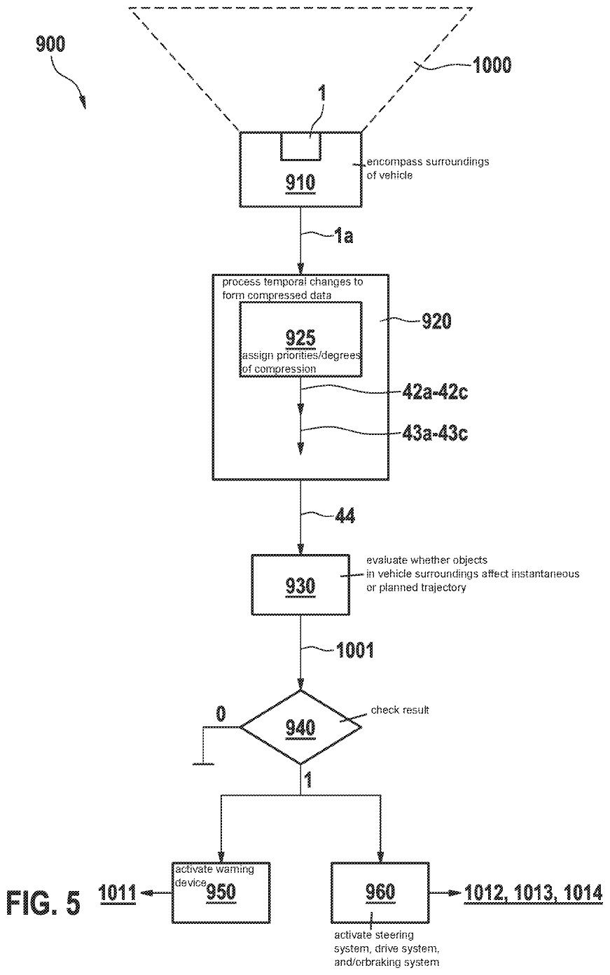

FIG. 5 shows one exemplary embodiment of method 900. To monitor and/or to control vehicle 1010, surroundings 1000 of vehicle 1010 are encompassed in step 910 with a sensor 1. Sensor 1 provides measured data 1a which, as described above, may optionally be improved to a pre-processed version 2a. In step 920, above-described method 400 is carried out in order to process temporal changes 1a′, 2a′, 31′ through 36′ of measured data 1a, 2a and/or of data 31 through 36 prepared therefrom to form compressed data 44. According to block 925, priorities 42a through 42c, and thus also degrees of compression 43a through 43c assigned to classes and/or regions 41a through 41c within the scope of method 400 may in this case be based, in particular, on whether an object 1001 represented by measured data 1a, 2a and/or prepared data 31 through 36 of respective class and/or region 41a through 41c potentially affects an instantaneously driven trajectory 1010a and/or a planned trajectory 1010b of vehicle 1010.

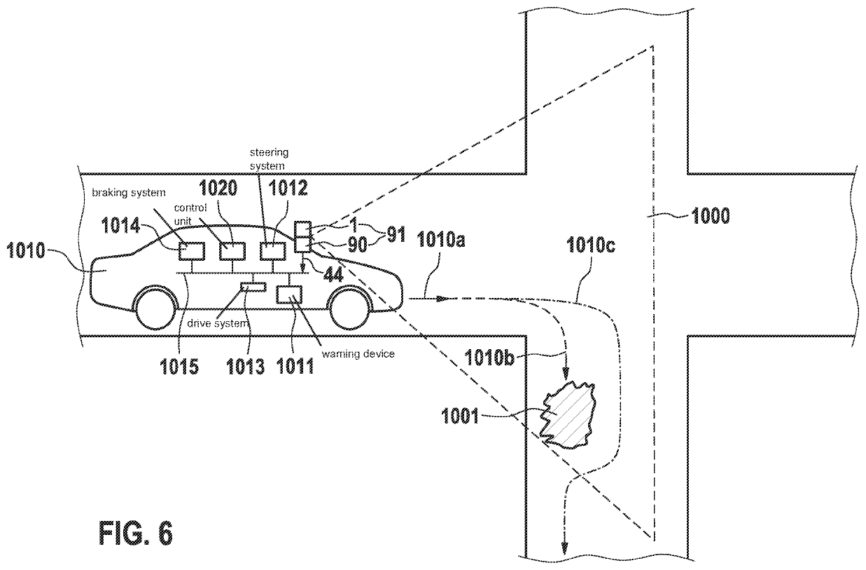

In step 930, compressed data 44 are used for evaluating whether there are objects 1001 in vehicle surroundings 1000, which affect instantaneously driven trajectory 1010 and/or a planned trajectory 1010b of vehicle 1010, cf. FIG. 6. The result is checked in step 940. If there are affecting objects (truth value 1), a warning device 1011 perceptible to the driver of vehicle 1010 may be activated in step 950. Alternatively or in combination therewith, a steering system 1012, a drive system 1013 and/or a braking system 1014 of vehicle 1010 may according to step 960 be activated to the extent that object 1001 no longer affects the then new trajectory 1010c of vehicle 1010.

A corresponding exemplary situation is delineated in FIG. 6. Here, vehicle 1010 is presently driving on a trajectory 1010a and intends to continue the trip on trajectory 1010b. This planned trajectory 1010b, however, is affected by an obstacle 1001 which, due to method 900 and method 400 used there as a subroutine, is identified more rapidly than previously. Vehicle 1010 is then rerouted onto a new trajectory 1010c, which bypasses obstacle 1001.

Sensor 1 used for detecting surroundings 1000 of vehicle 1010 is part of a camera module 91, which also contains the above-described compression module 90. Thus, only highly compressed data 44 are provided on internal network 1015 of vehicle 1010. Connected to internal network 1015 are, for example, central control unit 1020 for the at least semi-automated driving, warning device 1011, steering system 1012, drive system 1013 and braking system 1014 of vehicle 1010.

1-13. (canceled)

14. A method for lossy compression of measured data, which have been obtained through physical observation of a detection area, the method comprising the following steps:
dividing with respect to at least one criterion the measured data and/or data prepared from the measured data, into a plurality of classes and/or regions;
assigning the classes and/or the regions priorities with respect to an intended evaluation of the measured data and/or of the prepared data; and
compressing, in a lossy manner, temporal changes of the measured data and/or of the prepared data divided into each of the classes and/or region, a degree of compression being a function of the priority which is assigned to the class and/or region.

15. The method as recited in claim 14, wherein the temporal changes are coded in the form of a flow field that includes a temporal sequence of flow vectors.

16. The method as recited in claim 15, wherein the flow field is compressed by discarding certain of the flow vectors from the temporal sequence.

17. The method as recited in claim 14, wherein the measured data include two-dimensional image data and the prepared data include a three-dimensional reconstruction obtained from the image data.

18. The method as recited in claim 14, wherein: (i) the prepared data contain a semantic segmentation of the measured data, and/or (ii) at least one criterion for the dividing of the measured data and/or the prepared data into the classes and/or regions is predefined by a semantic segmentation of the measured data.

19. The method as recited in claim 14, wherein: (i) the prepared data contain a classification of objects, whose presence is indicated by the measured data, and/or (ii) at least one criterion for the dividing of the measured data and/or the processed data into the classes and/or regions is predefined by the classification of the objects,

20. The method as recited in claim 14, wherein: (i) the prepared data contain a prognosis of movement behavior of objects, and/or (ii) at least one criterion for the dividing of the measured data and/or the prepared data into the classes and/or regions is predefined by the prognosis of the movement behavior of the objects.

21. A method for monitoring a vehicle driving in traffic, and/or for controlling the vehicle driving in at least a semi-automated manner, the method comprising the following steps:
detecting measured data through physical observation of at least one portion of surroundings of the vehicle;
compressing temporal changes of the measured data and/or data prepared from the measured data by:
dividing with respect to at least one criterion the measured data and/or the prepared data, into a plurality of classes and/or regions,
assigning the classes and/or the regions priorities with respect to an intended evaluation of the measured data and/or of the prepared data, and
compressing, in a lossy manner, the temporal changes of the measured data and/or of the prepared data divided into each of the classes and/or region, a degree of compression being a function of the priority which is assigned to the class and/or region;
using the compressed temporal changes for an evaluation of whether there are objects in the surroundings of the vehicle, which affect an instantaneously driven trajectory of the vehicle and/or a planned trajectory of the vehicle.

22. The method as recited in claim 21, wherein the priority assigned to at least one of the classes and/or regions is based at least on whether an object represented by measured data and/or prepared data of the class and/or region: (i) potentially affects an instantaneously driven trajectory of the vehicle and/or a planned trajectory of vehicle, and/or (ii) whether the object may collide with the vehicle.

23. The method as recited in claim 21, wherein: (i) a physical warning device perceptible to a driver of the vehicle is activated in response to evaluating that there is at least one object in the surroundings of the vehicle that affects the instantaneously driven trajectory of the vehicle and/or the planned trajectory of the vehicle, and/or (ii) a steering system of the vehicle, and/or a drive system of the vehicle, and/or a braking system of the vehicle, is activated to the extent that the object no longer affects a then new trajectory of the vehicle.

24. A compression module, connectable on an input side with at least one sensor, which provides a pictorial representation of at least one portion of surroundings of a vehicle as measured data, connectable on an output side with a component-internal data line and/or with a bus system and/or network of the vehicle, and configured to:
divide with respect to at least one criterion the measured data and/or data prepared from the measured data, into a plurality of classes and/or regions;
assign the classes and/or the regions priorities with respect to an intended evaluation of the measured data and/or of the prepared data; and
compress, in a lossy manner, temporal changes of the measured data and/or of the prepared data divided into each of the classes and/or region, a degree of compression being a function of the priority which is assigned to the class and/or region.

25. A camera, or a radar module, or a LIDAR module for a pictorial recording of at least one portion of surroundings of a vehicle, including at least one compression module connectable on an input side with at least one sensor, which provides a pictorial representation of at least one portion of surroundings of a vehicle as measured data, connectable on an output side with a component-internal data line and/or with a bus system and/or network of the vehicle, and configured to:
divide with respect to at least one criterion the measured data and/or data prepared from the measured data, into a plurality of classes and/or regions;
assign the classes and/or the regions priorities with respect to an intended evaluation of the measured data and/or of the prepared data; and
compress, in a lossy manner, temporal changes of the measured data and/or of the prepared data divided into each of the classes and/or region, a degree of compression being a function of the priority which is assigned to the class and/or region.

26. A non-transitory machine-readable storage medium on which is stored a computer program for lossy compression of measured data, which have been obtained through physical observation of a detection area, the computer program, when executed by a computer, causing the computer to perform the following steps:
dividing with respect to at least one criterion the measured data and/or data prepared from the measured data, into a plurality of classes and/or regions;
assigning the classes and/or the regions priorities with respect to an intended evaluation of the measured data and/or of the prepared data; and
compressing, in a lossy manner, temporal changes of the measured data and/or of the prepared data divided into each of the classes and/or region, a degree of compression being a function of the priority which is assigned to the class and/or region.
